(19) United States
(12) Patent Application Publication
(10) Pub. No.: US 2010/0182391 A1
(43) Pub. Date: Jul. 22, 2010

(54) EXPOSURE DEVICE, IMAGE FORMING APPARATUS AND COMPUTER-READABLE MEDIUM

(75) Inventors: Osamu Yasui, Ebina-shi (JP); Michihiro Inoue, Ebina-shi (JP); Ken Tsuchiya, Ebina-shi (JP); Michio Taniwaki, Ebina-shi (JP); Toshio Hisamura, Kawasaki-shi (JP); Fumihiko Ogasawara, Ebina-shi (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 12/563,467

(22) Filed: Sep. 21, 2009

(30) Foreign Application Priority Data
Jan. 16, 2009 (JP) 2009-007247

(51) Int. Cl. B41J 2/435

(52) U.S. Cl. 347/224

(57) ABSTRACT

An exposure device includes an exposure section and first and second signal output units. The exposure section has plural light emitting elements. The first signal output unit outputs to the exposure section a first signal for determining timings for starting and ending light emission of the respective light emitting elements. The second signal output unit outputs to the exposure section a second signal for determining as to whether the respective light emitting elements are caused to emit light for respective pixels. If light mission of the respective light emitting elements is stopped with respect to all pixels of one line in a main scanning direction, the first signal does not output to the exposure section for each group of one or plural light emitting elements that operate based on the common first signal.

### CROSS-REFERENCE TO RELATED APPLICATIONS

This application is based on and claims priority under 35 USC 119 from Japanese Patent Application No. 2009-7247 filed Jan. 16, 2009.

### BACKGROUND

### Technical Field

The present invention relates to an exposure device, an image forming apparatus and a computer-readable medium storing a program that causes a computer to execute an exposure control process.

### SUMMARY

According to an aspect of the invention, an exposure device includes an exposure section, a first signal output unit, a second signal output unit and a controller. The exposure section has a plurality of light emitting elements. The first signal output unit outputs to the exposure section a first signal for determining a timing for starting light emission of the respective light emitting elements and a timing for ending the light emission of the respective light emitting elements. The second signal output unit outputs to the exposure section a second signal for determining as to whether or not the respective light emitting elements are caused to emit light for respective pixels. If light mission of the respective light emitting elements is stopped with respect to all pixels of one line in a main scanning direction, the first signal output unit does not output the first signal to the exposure section for each group of one or plural light emitting elements that operate based on the common first signal.

### BRIEF DESCRIPTION OF THE DRAWINGS

Exemplary embodiments of the invention will be described in detail based on the accompanying drawings, wherein

FIG. 1 is a view showing the entire configuration of an image forming apparatus according to an exemplary embodiment of the present invention;

FIG. 2 is a sectional view showing the configuration of an LED print head of the image forming apparatus according to one exemplary embodiment of the present invention;

FIG. 3 is a plan view of an LED array 23, having plural LED chips arranged therein, of the image forming apparatus according to the one exemplary embodiment of the present invention;

FIG. 4 is a circuit diagram showing a light emitting element array driving unit in the LED print head, for which a self-scanning LED is adopted, of the image forming apparatus according to the one exemplary embodiment of the present invention;

FIG. 5 is a circuit diagram showing the light emitting element array driving unit of the image forming apparatus according to the one exemplary embodiment of the present invention;

FIG. 6 is a timing chart of operations of respective parts of the light emitting element array of the image forming apparatus according to the one exemplary embodiment of the present invention;

FIG. 7 is a view showing current flows in a level shift circuit when a transfer signal CK1R is turned from a default level to an L level in the image forming apparatus according to the one exemplary embodiment of the present invention;

FIG. 8 is a view showing current flows immediately after the transfer signal CKS is turned to a H level and CK1C is turned to an L level in the image forming apparatus according to the one exemplary embodiment of the present invention;

FIG. 9 is a view showing potentials of respective parts in a steady state where a thyristor S1 is completely turned on, in the image forming apparatus according to the one exemplary embodiment of the present invention;

FIG. 10 is a view showing a state, where gate current flows through a thyristor S2, in the image forming apparatus according to the one exemplary embodiment of the present invention;

FIG. 11 is a timing chart of image data in the image forming apparatus according to the one exemplary embodiment of the present invention;

FIG. 12 is a circuit diagram showing the entire circuit configuration of a circuit provided in a driving device in the image forming apparatus according to the one exemplary embodiment of the present invention;

FIG. 13 is a schematic diagram for explaining storing of image data in FIFO of the image forming apparatus according to the one exemplary embodiment of the present invention;

FIG. 14 is a schematic diagram for explaining storing of image data in a holding memory for one line in the image forming apparatus according to the one exemplary embodiment of the present invention;

FIG. 15 is a circuit diagram of a determination circuit in the image forming apparatus according to the one exemplary embodiment of the present invention;

FIG. 16 is a circuit diagram showing the circuit configuration of a transfer prohibition circuit in the image forming apparatus according to the one exemplary embodiment of the present invention;

FIG. 17 is a block diagram for explaining the entire configuration of a control system of an exposure device in the image forming apparatus according to the one exemplary embodiment of the present invention;

FIG. 18 is a timing chart showing writing of image data from a control side to a FIFO memory in the image forming apparatus according to the one exemplary embodiment of the present invention;

FIG. 19 is a timing chart showing writing of image data into the holding memory for one line from reading of the image data from the FIFO memory in the image forming apparatus according to the one exemplary embodiment of the present invention;

FIG. 20 is a timing chart showing output of image data to four LED chips SLED1, SLED2, SLED3 and SLED4 from reading of the image data from the holding memory for one line in the image forming apparatus according to the one exemplary embodiment of the present invention;

FIG. 21 is a timing chart showing writing of image data from the control side into the FIFO memory in a comparative example;

FIG. 22 is a timing chart showing writing of image data into the holding memory for one line from reading of image data from the FIFO memory in the comparative example; and

FIG. 23 is a timing chart showing output of image data to the four LED chips SLED1, SLED2, SLED3 and SLED4 from reading of the image data from the holding memory for one line in the comparative example.

### DETAILED DESCRIPTION

Hereinafter, exemplary embodiments of the present invention of the invention will be described.

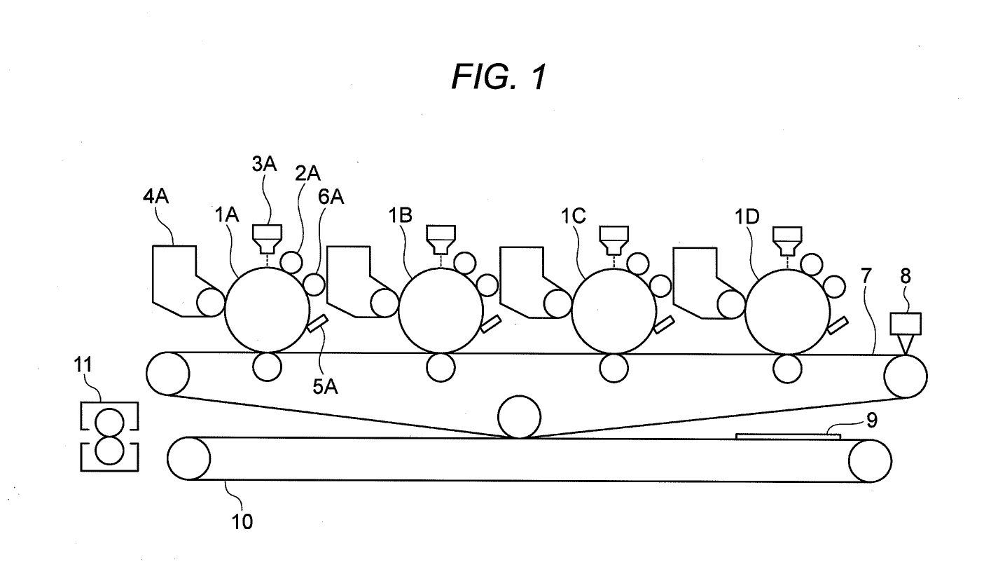

FIG. 1 is a view showing the entire configuration of an image forming apparatus according to an exemplary embodiment of the present invention.

The image forming apparatus is able to form a color image on a printing medium by a tandem type electrophotography system. The image forming apparatus is configured so that four drum-shaped photosensitive bodies 1A, 1B, 1C and 1D are arranged around an intermediate transfer belt 7. Various types of devices and units to form images by the electrophotography process are disposed around the photosensitive bodies 1A, 1B, 1C and 1D, respectively. Since the configurations of these devise and units are common to the photosensitive bodies 1A, 1B, 1C and 1D, herein, description is given of devices and units around the photosensitive body 1A as representative. That is, a charger 2A, a print head 3A, a developing device 4A, a cleaner 5A, and a charge neutralizer 6A are arranged around the photosensitive body 1A. A toner image is formed on the photosensitive body 1A with a yellow (Y) developing agent (also, in the following description, the photosensitive bodies 1A, 1B, 1C and 1D may be collectively referred to as the “photosensitive body” 1, and this is the same as for the charger 2A, the print head 3A, the developing device 4A, the cleaner 5A, and the charge neutralizer 6A). Similarly, toner images of magenta (M), cyan (C) and black (K) are formed on the photosensitive bodies 1B, 1C and 1D, respectively. The respective toner images are stacked on each other and transferred onto the intermediate transfer belt 7 while matching their positions based on detection signals of a registration sensor 8, and all the toner images are collectively transferred onto a recording sheet 9. The recording sheet 9 is conveyed to a fixing device 11 by means of a sheet conveyance belt 10. The fixing device 11 fixes the toner images on the recording sheet 9 (an example of a printing medium), thereby forming a color image.

Since, in such a tandem type color image forming apparatus, image forming units of respective colors Y, M, C and K are independently arranged, it may be required to downsize the respective units. Therefore, it may demanded for the print head that a space occupancy ratio around the photosensitive body circumference is downsized to as minimum extent as possible. An LED print head may be adopted, which uses an LED array in which a large number of light emitting diodes (LEDs) are arranged.

In the following description, detailed description is given on an exposure device for exposing a surface of the photosensitive body 1 using the print head 3A.

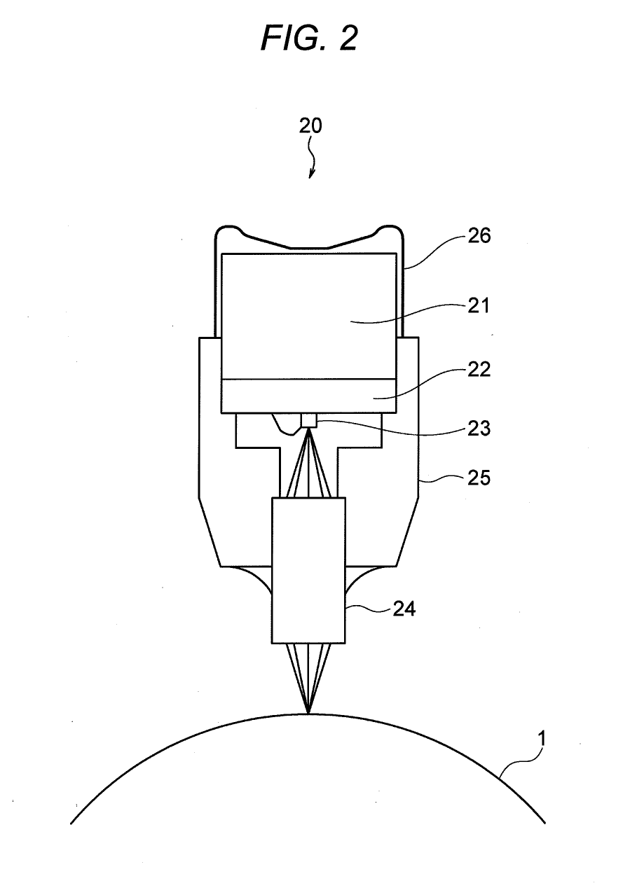

FIG. 2 is a sectional view showing the configuration of an LED print head.

The LED print head 20 is a light emitting element for exposure of the photosensitive body and is provided on the print head 3. The LED print head 20 is provided with a housing 21 serving as a supporting body, a printed circuit board 22 having a light emitting element array driver 50 (which will be described later) mounted thereon, an LED array 23 for emitting exposure light, a SELFOC® lens array (SELFOC lens is a registered trademark of Nippon Sheet Glass Co., Ltd.) for focusing light from the LED array 23 onto the surface of the photosensitive drum 1, a SELFOC lens array holder 25 for supporting the SELFOC lens array 24 and shielding the LED array 23 from the outside, and a leaf spring 26 for pressing the housing 21 in the SELFOC lens array 24 direction.

The housing 21 is formed of an aluminum or stainless steel block or made of an aluminum or stainless steel sheet material, and supports the printed circuit board 22 and the LED array 23. Also, the SELFOC lens array holder 25 supports the housing 21 and the SELFOC lens array 23, and is configured so that the light emitting point of the LED array 23 is aligned with the focal point of the SELFOC lens array 24. Further, the SELFOC lens array holder 25 is disposed so as to closely seal the LED array 23. Therefore, no foreign substances such as dust are adhered to the LED array 23 from the outside. On the other hand, the leaf spring 26 presses in the direction of the SELFOC lens array 24 via the housing 21 so as to maintain the positional relationship between the LED array 23 and the SELFOC lens array 24.

The LED print head 20 is configured so as to be movable in an optical axis direction of the SELFOC lens array 24 by an adjustment screw (not illustrated), and is adjusted so that an image formation position (the focal point) of the SELFOC lens array 24 is located on the surface of the photosensitive drum 1.

In the LED array 23, as described later, plural LED chips 40 are accurately arranged on a chip substrate to form a row and to be parallel to a shaft direction of the photosensitive drum 1. In the SELFOC lens array 24, self-converging fibers are accurately arranged to form a row and to be parallel to the shaft direction of the photosensitive drum 1. And, light from the LED array 23 is focused on the surface of the photosensitive drum 1, and a latent image is formed thereon.

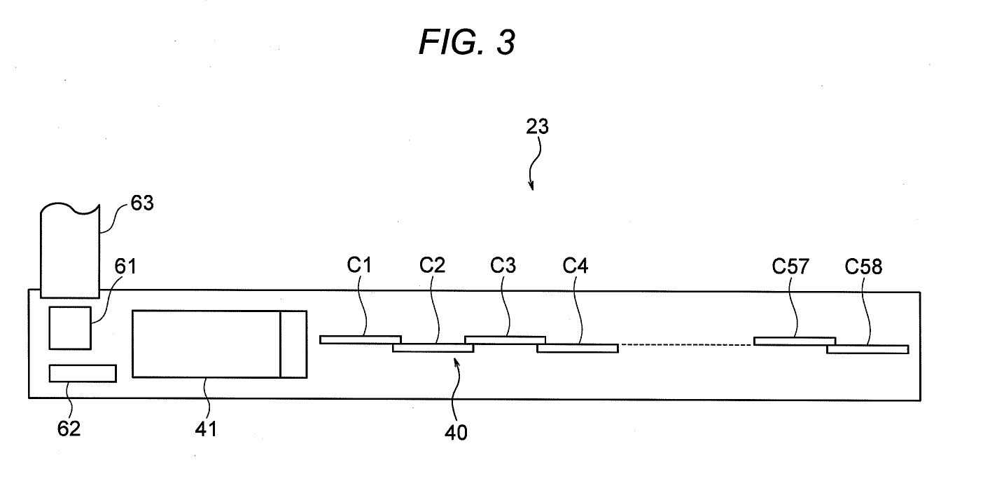

FIG. 3 is a plan view of the LED array 23 having plural LED chips 40 arranged therein.

In the LED array 23, 58 LED chips 40 (C1 through C58) are accurately arranged to form a row and to be parallel to the shaft direction of the photosensitive drum 1. The respective LED chips 40 are arrayed in a zigzag manner. And, in the LED print head 20, 128 LEDs are incorporated in each of the LED chips 40. In addition, the LED array 23 is provided with a driver 41 to drive the LED chips 40. Further, the LED array 23 is provided with a power circuit 61 to stabilize an output voltage, an EEPROM 62 to store light amount correction value data of the respective LEDs which constitute the LED chip 40, and a harness 63 for transmitting and receiving signals between the LED array 23 and an image forming apparatus main body.

Self-scanning LEDs are adopted in the LED print head 20. The self-scanning LED adopts a thyristor structure as a portion equivalent to a switch that selectively turns on and off a light emitting point. By adopting the thyristor structure, it becomes possible to arrange the switching portion on the same chip as that of the light emitting point. Also, turn-on timing and turn-off timing of the switch are selectively controlled for lighting by two signal lines. This provides such advantageous effects that the data line can be made common and that the wiring thereof is simplified.

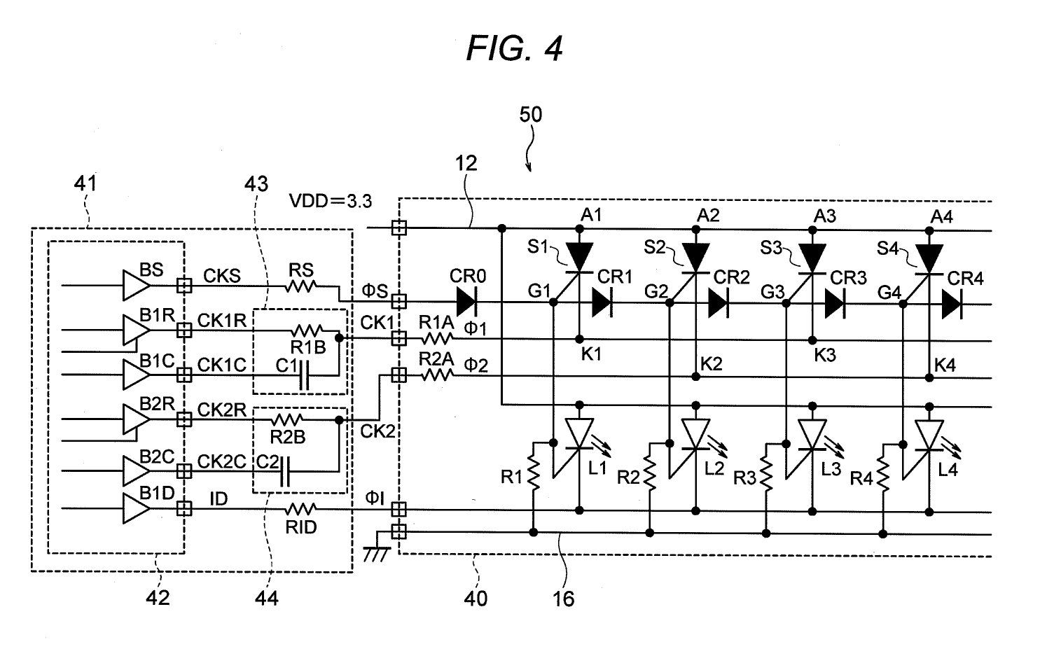

FIG. 4 is a circuit diagram showing the light emitting element array driver 50 in the LED print head 20 in which the self-scanning LEDs are adopted.

In FIG. 4, the light emitting element array driver 50 is provided with the LED chip 40 and the driver 41 to drive the LED chip 40. The LED chip 40 includes “n” thyristors S1, S2, . . . Sn (in the figure, the thyristors are appropriately illustrated by equivalent circuits), “n” light emitting diodes (LEDs) L1, L2, . . . Ln, and “n+1” diodes CR0, CR1, CR2, . . . CRn, etc. In addition, the driver 41 includes resistors RS, R1B, R2B, RID, capacitors C1, C2 and a signal generation circuit 42, etc. Also, in FIG. 4, only some of the thyristors, the light emitting diodes, and the diodes, which are provided in the LED chip 40, are illustrated.

Hereinafter, description is given on a circuit configuration of the LED chip 40 and the driver 41. Anode terminals A1 through An of the respective thyristors S1 through Sn are connected to the power line 12. A power voltage VDD (VDD=3.3V) is supplied to the power line 12. Cathode terminals K1, K3, . . . of the thyristors having an odd number (A1, A3, . . . ) are connected to the signal generation circuit 42 via the resistor R1A. A level-shift circuit 43 in which a signal line having the resistor R1B connected thereto and a signal line having the capacitor C1 connected thereto are branched in parallel to each other is connected between the resistor R1A and the signal generation circuit 42. Furthermore, cathode terminals K2, K4, . . . of the thyristors having an even number (S2, S4, . . . ) are connected to the signal generation circuit 42 via the resistor R2A. A level-shift circuit 44 in which a signal line having the resistor R2B connected thereto and a signal line having the capacitor C2 connected thereto are branched in parallel to each other is connected between the resistor R2A and the signal generation circuit 42.

On the other hand, gate terminals G1 through Gn of the respective thyristors S1 through Sn are connected to a power line 16 via resistors R1 through Rn which are provided so as to correspond to the respective thyristors S1 through Sn, respectively. In addition, the power line 16 is grounded (GND).

The gate terminals G1 through Gn of the thyristors S1 through Sn are, respectively, connected to the gate terminals of the light emitting diodes L1 through Ln which are provided so as to correspond to the respective thyristors S1 through Sn.

Further, anode terminals of the diodes CR1 through CRn are connected to the gate terminals G1 through Gn of the respective thyristors S1 through Sn. Cathode terminals of the diodes CR1 through CRn are, respectively, connected to the gate terminals of the next stage. That is, the respective diodes CR1 through CRn are connected to each other in series.

The anode terminal of the diode CR1 is connected to the cathode terminal of the diode CR0, and the anode terminal of the diode CR0 is connected to the signal generation circuit 42 via the resistor RS. Further, the cathode terminals of the light emitting diodes L1 through Ln are connected to the signal generation circuit 42 via the resistor RID. Still further, the light emitting diodes L1 through Ln are composed of AlGaAsP or GaAsP as an example, and its band gap is approximately 1.5V.

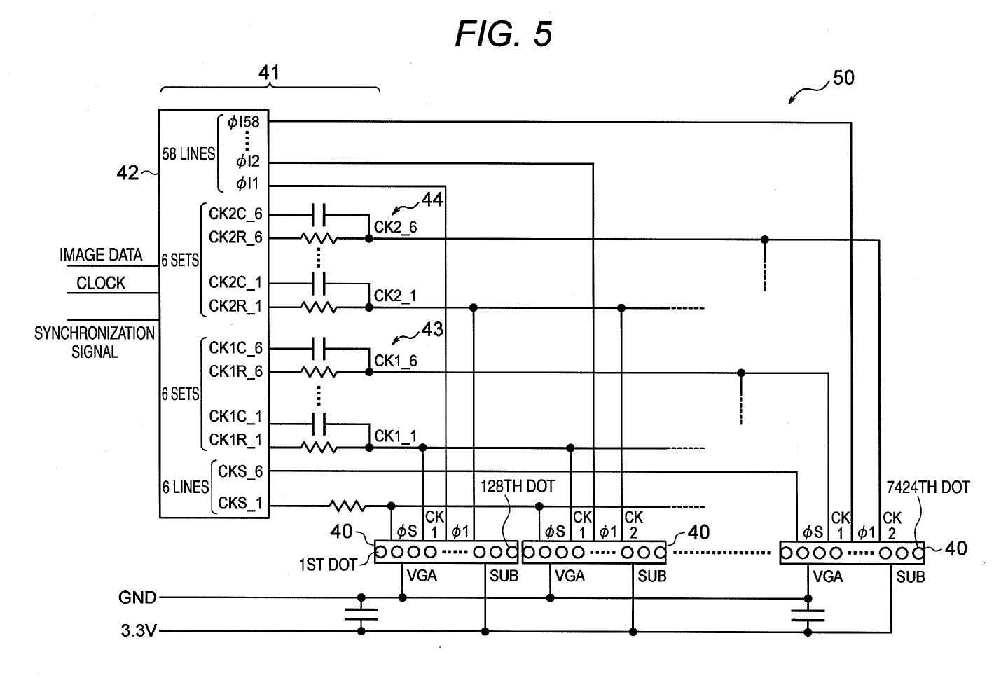

FIG. 5 is a circuit diagram showing the light emitting element array driver 50.

FIG. 5 shows the configuration of recording on an A3-sized recording sheet at 600 dpi (dot per inch) and driving a 7424-dot LED element. That is, the LED print head 20 according to this exemplary embodiment has fifty eight LED chips 40, each of which is composed of 128 dots.

In FIG. 5, ID that is an LED lighting signal is provided for each LED chip 40, and 58 IDs are arranged in total. Also, each of the transfer signals CK1, CK2, CKS drive 9 or 10 chips. Six sets of the transfer signals CK1, CK2, CKS are arranged in total. The level shift circuits 43 and 44 (see FIG. 4) are provided for each of the sets. With this configuration, there is no need to provide a large drive capacity for each of the transfer signals CK1, CK2 and CKS, and all the LED chips 40 can be driven stably at a low voltage.

Self-scanning LEDs are adopted in the LED print head 20. The self-scanning LEDs employ the thyristor structure as a portion corresponding to a switch that selectively turns on and turns off the light emitting points. By using the thyristor structure, the switching portions can be disposed on the same chip as the light emitting points. In addition, the turn-on timing and turn-off timing of the switch are selectively controlled for lighting by two signal lines. This provides such advantageous effect that the data line can be made common and that the wiring thereof is simplified.

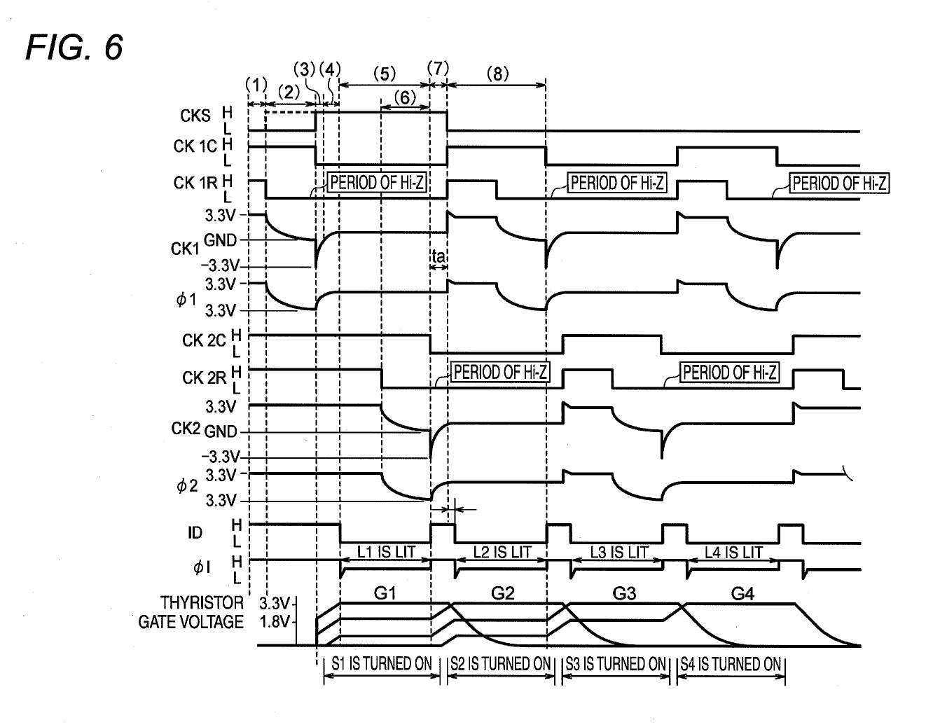

Next, description is given on operations of the light emitting element array driver 50 shown in FIG. 4 with reference to a timing chart shown in FIG. 6. In FIG. 6, by showing the symbols, which are assigned to the signal lines in FIG. 4, it is made clear to which signals of the circuit in FIG. 4 the respective signals correspond. Also, in the following description, description is given on the case where four thyristors (n=4) are provided, as an example.

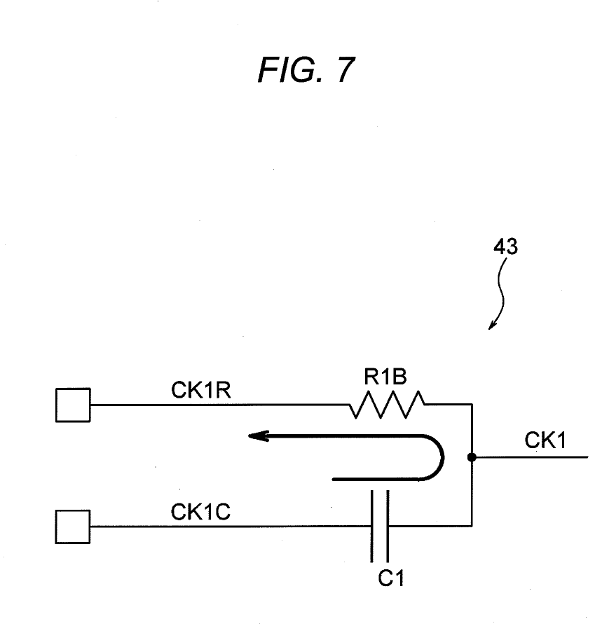

(1) First, in a default state, all the thyristors S1, S2, S3 and S4 are turned off since no current flows thereto (FIG. 6(1)).
(2) As the transfer signal CK1R is brought from the default state to an L level (FIG. 6(2)), current flows through the level shift circuit 43 in a direction of an arrow as shown in FIG. 7, and a potential of the transfer signal CK1 becomes GND. Since the potential of the transfer signal CK1 is 3.3V in this example, a potential difference between the both ends of the capacitor C1 is 3.3V (VDD). In this case, as shown by the dotted-line in the timing of FIG. 6(2), the transfer signal CKS may be set to a H level.
(3) Simultaneously therewith, if the transfer signal CKS is set to the H level and the transfer signal CK1C is set to an L level (FIG. 6(3)), the potential of the transfer signal CK1 becomes approximately −3.3V since electric charge is accumulated in the capacitor C1. Also, the potential of the gate G1 becomes φS potential−Vf=approximately 1.8V. Here, the φS potential is approximately 3.3V, and Vf means a forward direction voltage of the diode of AlGaAs and is approximately 1.5V. Further, φ1 potential=G1 potential−Vf=0.3V is brought about. Therefore, a potential difference of approximately 3.7V is produced between the signal line φ1 and the transfer signal CK1.

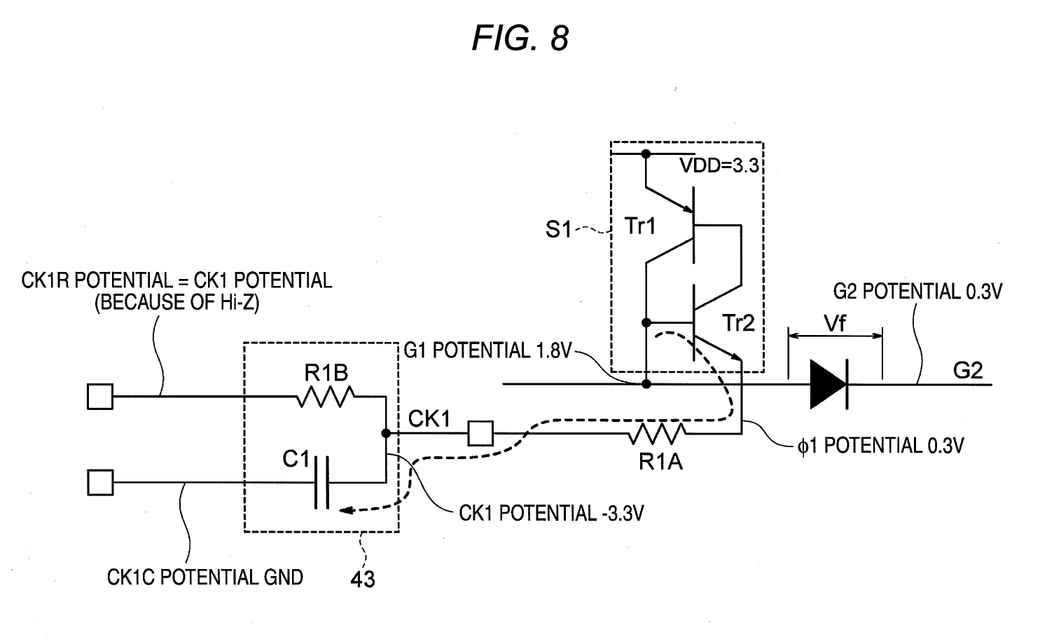

And, in this state, gate current of the thyristor S1 begins flowing in the route of the gate G1→signal line φ1→transfer signal CK1 as shown in FIG. 8. At this time, a tri-state buffer B1R is turned into a high impedance (Hi-Z), wherein reverse flow of the current is prevented.

After that, Tr2 is turned on by the gate current of the thyristor S1, and the base current of Tr1 (collector current of Tr2) is caused to flow, and Tr1 is turned on, thereby causing the thyristor S1 to start turning on, and the gate current to gradually rise. In line therewith, since current flows in the capacitor C1 of the level shift circuit 43, the potential of the transfer signal CK1 gradually rises.

(4) After a predetermined duration of time (that is, a time period in which the potential of the transfer signal CK1 is brought into the vicinity of GND) elapses, the tri-state buffer B1R of the signal generation circuit 42 is brought to an L level (FIG. 6(4)). If so, the potential of the signal line φ1 rises, and the potential of the transfer signal CK1 rises in line with a rise in the potential of the gate G1. Further, in line therewith, current begins flowing to the resistor R1B side of the level shift circuit 43. On the other hand, the current flowing in the capacitor C1 of the level shift circuit 43 gradually decreases in line with a rise in the potential of the transfer signal CK1.

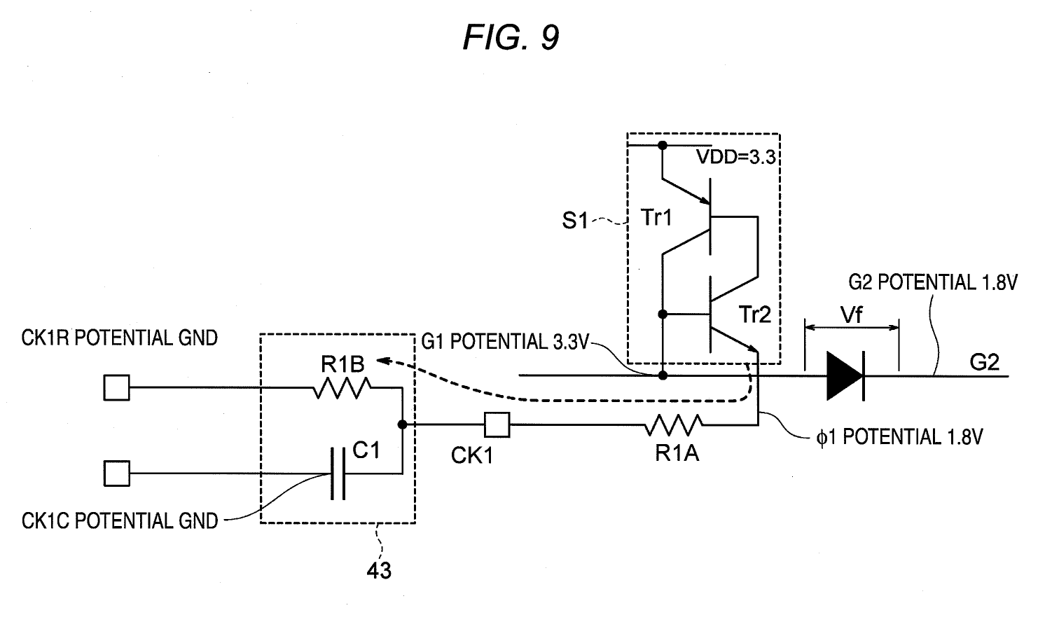

Then, as the thyristor S1 is completely turned on and is brought into a steady state, the potentials of the respective signal lines become as shown in FIG. 9. That is, although current to keep the thyristor S1 in a turned-on state flows in the resistor R1B of the level shift circuit 43, no current flows in the capacitor C1. Further, the potential of the transfer signal CK1 is CK1 potential=1.8−1.8×R1B/(R1A+R1B).

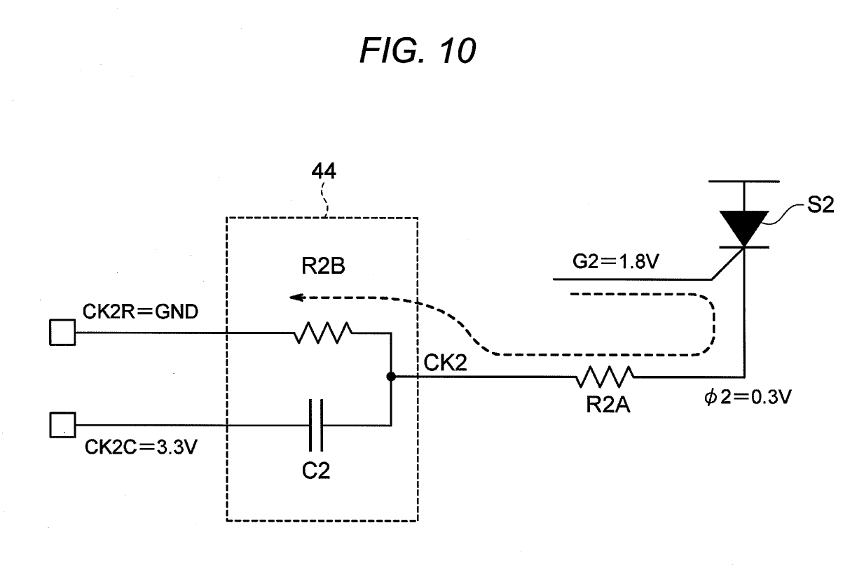

(5) The lighting signal ID is brought to an L level with the thyristor S1 being completely turned on (FIG. 6(5)). At this time, since the gate G1 potential is larger than the gate G2 potential (Gate G1 potential−Gate G2 potential=1.8V), the LED L1 of the thyristor structure is turned on earlier and is lit. In line with lighting of the LED L1, the potential of the signal line φ1 rises to cause signal line φ1 potential=gate G2 potential=1.8V to be brought about. Therefore, the LEDs including LED L2 and subsequent LEDs will not be turned on. That is, among the LEDs L1, L2, L3, L4 . . . , only the LED having the highest gate voltage is turned on (lit).
(6) Next, as the transfer signal CK2R is set to an L level (FIG. 6(6)), current flows as in the case of FIG. 6(2), and a voltage is generated between the both ends of the capacitor C2 of the level shift circuit 44. In a steady state immediately before the step of FIG. 6(6) is finished, since the gate G2 potential is 1.8V, the voltage values at the respective points slightly differ from those in the case of FIG. 6(2). However, no influence is brought about. The reason is as described below. The potential of the signal line φ2 is 0.3V or so (=Gate G2 potential−Vf=1.8V −1.5V) in a steady state immediately before the step of FIG. 6(6) is finished. Therefore, the gate current flows to the thyristor S2 in the dotted line direction as shown in FIG. 10. However, since this gate current is only slight, the thyristor S2 is not turned on. In this case, the transfer signal CK2 potential is roughly 0.15V or so (=CK2 potential=0.3−0.3×R2B/(R2A+R2B).
(7) If the transfer signal CK2C is set to an L level in this state (FIG. 6(7)), the thyristor switch S2 is turned on.
(8) Then, if the transfer signals CK1C and CK1R are simultaneously set to the H level (FIG. 6(8)), the thyristor switch S1 is turned off, and the gate G1 potential gradually falls by discharge through the resistor R1. At this time, the gate G2 of the thyristor switch S2 becomes 3.3V, and is completely turned on. Therefore, by bringing lighting signal ID terminals corresponding to image data to L level/H level, the LED L2 can be brought into lighting and non-lighting. Also, in this case, since the gate G1 potential has already been lower than the gate G2 potential, the LED L1 will not be turned on.

Thus, according to the light emitting element array driver 50, the ON state of the thyristor switches of the thyristors S1, S2, Sn can be changed by alternately driving the transfer signals CK1 and CK2. Therefore, the LEDs L1, L2, Ln can be selectively controlled for lighting or non-lighting through time sharing.

In the above configuration, when the LED array 23 is heated, the positions on the photosensitive body onto which exposure light emitted from the respective LEDs on the LED array 23 are applied would shift due to thermal expansion of members. In particular, if an image of only one color of black (K) is continuously formed, only the LED array 23 of a print head 3 related to image formation of K is excessively heated, and if a color image is formed immediately thereafter, color shift would occur between toner images of Y, M, C and a toner image of K.

Heat based on output of the transfer signals CK1 and CK2 occupies a majority of the heat source for heating the LED array 23. Although the transfer signals CK1 and CK2 are generated based on the transfer signals CK1R, CK1C, CK2R and CK2C, the transfer signals CK1 and CK2 only give timings for starting and ending light emission in the case where the respective LEDs are caused to emit light. That is, what determines as to whether the respective LEDs are caused to emit light (a black image is formed) or the respective LEDs are not caused to emit light (a white image is formed) is an ID signal which is the LED lighting signal.

Therefore, even in the case where all the pixels of one line of image data for forming an image are white, that is, the LEDs are not caused to emit light for all the pixels of the one line of the image data, unnecessary transfer signals CK1 and CK2 are output if the above-described circuit configuration remains unchanged, and a temperature would rise in the LED array 23.

Also, when images for plural pages are formed, a pause time to suspend image formation exists between pages for which images are formed. The photosensitive drum turns even in this pause time. However, no image formation is executed on the photosensitive drum. In such a blank time, by causing the LEDs of the LED array 23 not to emit light by the ID signal, it is possible to suspend the image formation between the pages. However, the transfer signals CK1 and CK2 would be output even during this pause period.

According to such a configuration, although it becomes unnecessary to generate a signal (Page Sync Signal) indicating a timing of a start of image data for one page and a timing of an end of image data for one page, the transfer signals CK1 and CK2 are output even during the time in which image formation is suspended between pages. After all, this contributes to temperature rise in the LED array 23.

Accordingly, the light emitting element array driving device 50 is provided with a circuit configuration that prohibits output of the transfer signals CK1 and CK2 when all the pixels of one line of image data for forming an image are white, that is, the LEDs remain turned off for all the pixels of the one line. In this case, each of the transfer signals CK1 and CK2 drive nine to ten LED chips 40. Six sets of the transfer signals CK1 and six sets of the transfer signals CK2 are provided in total (see FIG. 5). Therefore, prohibition of the transfer signals CK1 and CK2 is carried out for each group of nine to ten LED chips 40.

Next, description will be given on a further detailed circuit configuration and operations of the driving device 41 of the light emitting element array driving device 50 provided with such a circuit configuration.

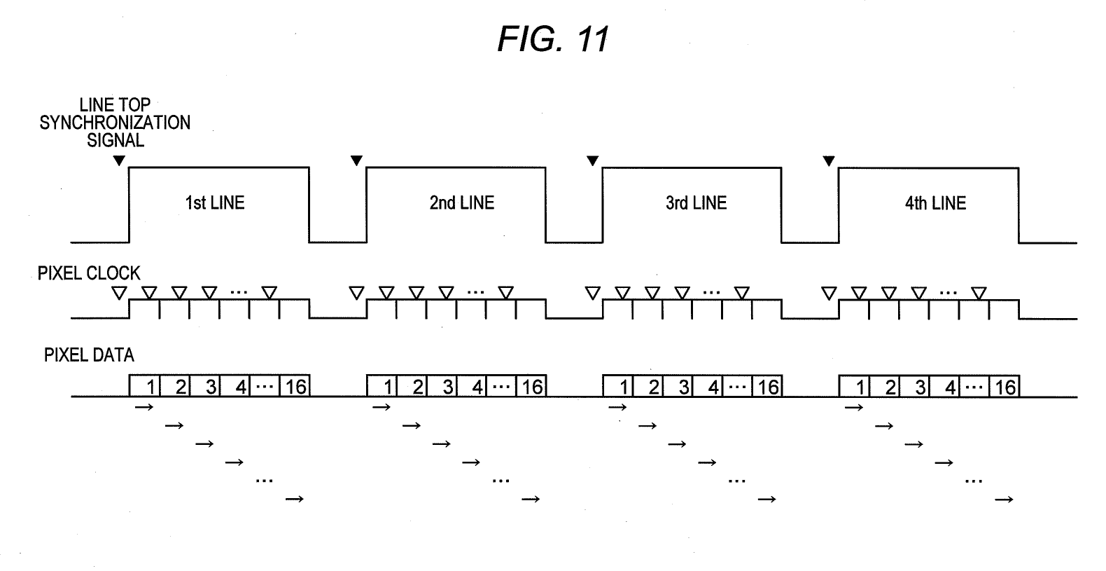

Hereinafter, for the sake of convenience in description, description will be given on the assumption that the LED array 23 is provided with four LED chips 40 and that one line of image data has 16 pixels. That is, FIG. 11 is a timing chart of image data in this case. A line top synchronization signal is a signal indicating, at a top of each line, a timing of the top of each line. Pixel data are image data of respective pixels included in each line, and one line consists of 16 pixels which are given numbers of 1, 2, . . . , 16. A pixel clock is a signal indicating a timing of each pixel.

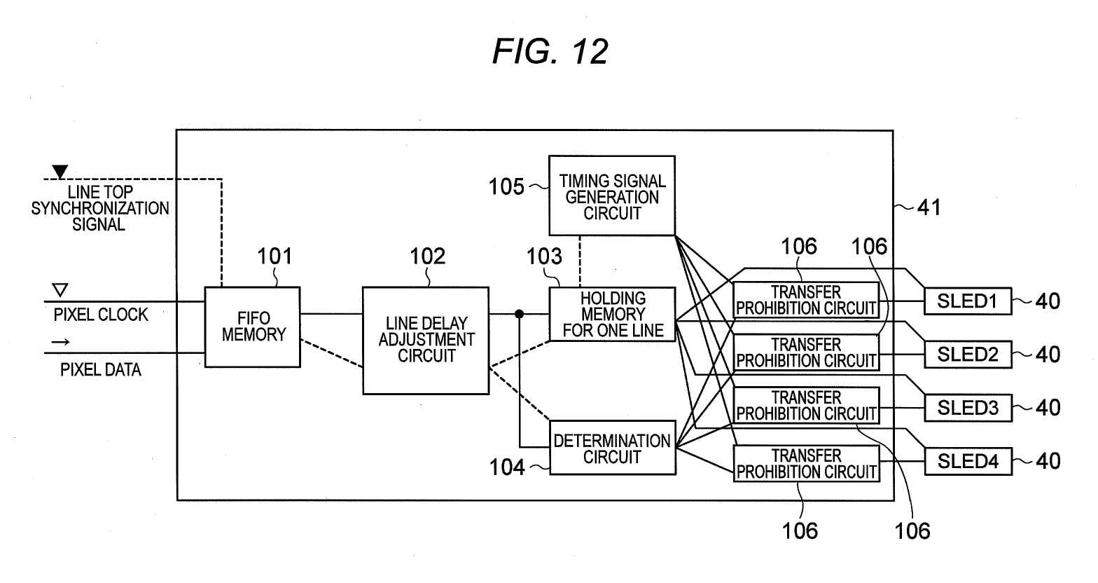

FIG. 12 is a circuit diagram showing the entire circuit configuration of circuits provided in the driving device 41.

In FIG. 12, the four LED chips 40 provided in the LED array 23 are expressed by SLED1, SLED2, SLED3 and SLED4. The line top synchronization signal, the pixel clock, and the pixel data constituting the image data are input to the driving device 41. A FIFO (First-In, First-Out) memory 101 once accommodates the image data received in synchronization with the line top synchronization signal and the pixel clock. A line delay adjustment circuit 102 carries out delay adjustment in the sub-scanning direction among the four LED chips 40. That is, as described above, the respective LED chips 40 are arrayed in the zigzag state. There are shifts in light emission timings based on the image data for one line among the LED chips 40. Therefore, the line delay adjustment circuit 102 adjusts these shifts.

The image data for which such adjustment has been executed are held in a holding memory 103 for one line. Further, the image data for which such adjustment has been executed are also transmitted to a determination circuit 104. The image data are added in the determination circuit 104. The result of the addition is fixed at a top of the next line. That is, addition of the image data is carried out for all the pixel data of one line. And, a transfer OFF signal is generated based on the result of the addition. The transfer OFF signal is a signal indicating as to whether or not the pixel data are 0 (to form a white image without causing the LEDs to emit light) with respect to all the pixel data for one line. Also, delay occurs on the determination circuit 104 side by one line. Therefore, if the amount of delay differs from that at the holding memory 103 side, it is necessary to adjust the amounts of delay on the both sides so that the amounts thereof are identical with each other when the amount of delay on the determination circuit 104 side is different from that on the holding memory 103 side. The result of the addition is cleared to be zero at every top of a line. The image data held in the holding memory 103 for one line become a source of calculation of a pulse width of the ID signal transmitted to the respective LED chips 40. An order of reading the pixel data from the holding memory 103 for one line is set to be an order of lighting of the LEDs in the SLED1, SLED2, SLED3 and SLED4. Thereby, the lighting order of the LEDs is re-arranged.

The timing signal generation circuit 105 generates the transfer signals CKS, CK1R, CK1C, CK2R and CK2C based on the line top synchronization signal (transmitted from the FIFO memory 101 to the line delay adjustment circuit 102, transmitted from the line delay adjustment circuit 102 to the holding memory 103 for one line and the judgement circuit 104, and further, transmitted from the holding memory 103 for one line to the timing signal generation circuit 105).

The transfer prohibition circuits 106 are connected to the preceding stages of the SLED1, SLED2, SLED3 and SLED4, respectively. The transfer signals CKS, CK1R, CK1C, CK2R and CK2C are output from the timing signal generation circuit 105 to the respective transfer prohibition circuits 106 corresponding to the SLED1, SLED2, SLED3 and SLED4, respectively. Also, the transfer OFF signal is output from the determination circuit 104. Further, the ID signals corresponding to the LED chips 40 are output from the holding memory 103 for one line to the SLED1, SLED2, SLED3 and SLED4.

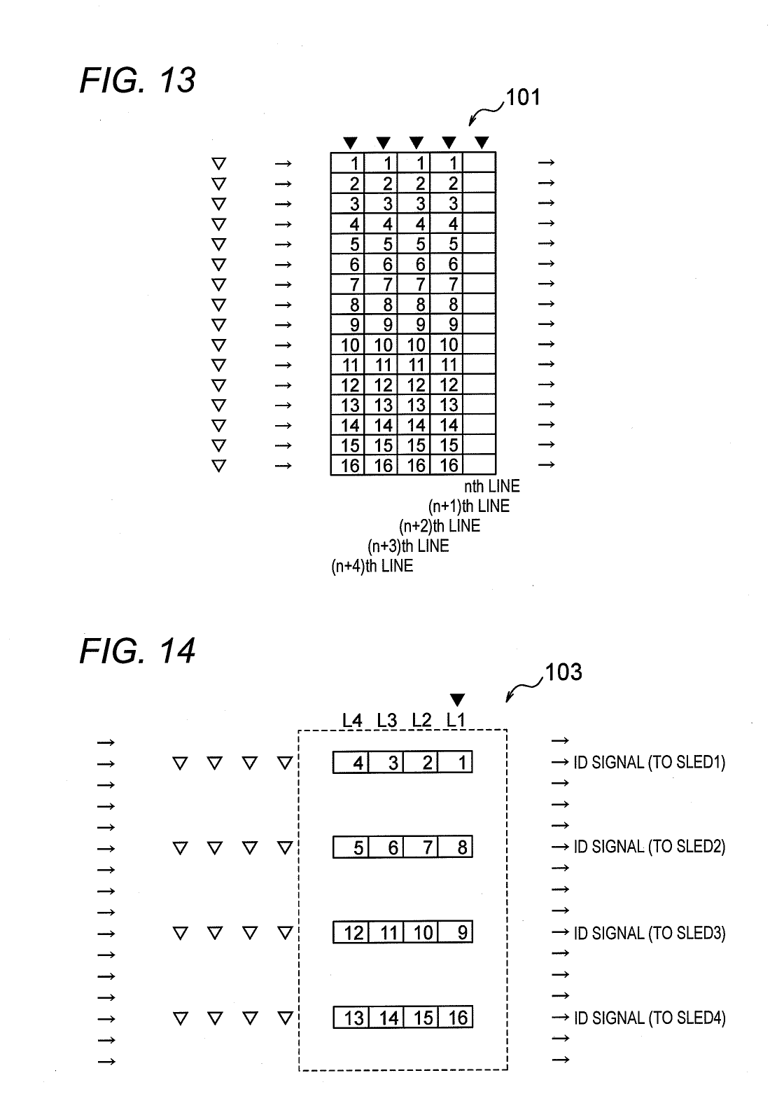

FIG. 13 is a schematic diagram of storing of image data in the FIFO memory 101.

Image data (respective pieces of image data 1, 2, . . . 16) for the respective main scanning lines are stored sequentially in order of nth, (n+1)th, (n+2)th, (n+3)th, and (n+4)th lines, and the image data (respective image data 1, 2, . . . 16) for the respective main scanning lines are output sequentially in order of the nth, (n+1)th, (n+2)th, (n+3)th, and (n+4)th lines.

FIG. 14 is a schematic diagram for explaining storing of the image data in the holding memory 103 for one line.

It is assumed that LEDs of one LED chip 40 are four LEDs L1, L2, L3, and L4 as shown in FIG. 4, image data 1, 2, 3, and 4 respectively correspond to the LEDs L1, L2, L3 and L4 of the SLED1, and are output from the holding memory 103 for one line to the SLED1 as the ID signal in order of the image data 1, 2, 3, and 4. Similarly, the image data 8, 7, 6, and 5 respectively correspond to the LEDs L1, L2, L3 and L4 of the SLED2, and are output from the holding memory 103 for one line to the SLED2 as the ID signal in order of the image data 8, 7, 6, and 5 image data. Also, the image data 9, 10, 11, and 12 respectively correspond to the LEDs L1, L2, L3 and L4 of the SLED3, and are output from the holding memory 103 for one line to the SLED3 as the ID signal in order of the image data 9, 10, 11 and 12. The image data 16, 15, 14 and 13 respectively correspond to the LEDs L1, L2, L3 and L4 of the SLED4, and are output from the holding memory 103 for one line to the SLED4 as the ID signal in order of the image data 16, 15, 14, and 13. In this case, the LEDs 1, 8, 9, and 16 are firstly turned on, the LEDs 2, 7, 10, and 15 are secondly turned on, the LEDs 3, 6, 11, and 14 are thirdly turned on, and the LEDs 4, 5, 12, and 13 are fourthly turned on. That ism logically, the image data (pulse width data) are re-arranged in the lighting order of the LEDs in the holding memory 103 for one line.

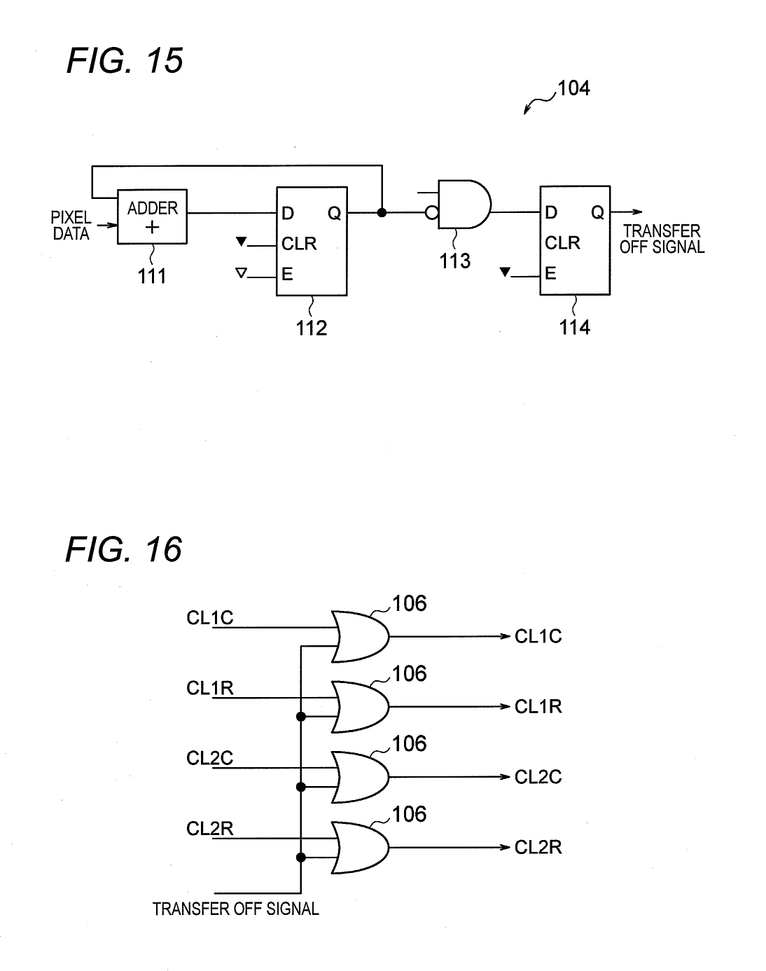

FIG. 15 is a circuit diagram of the determination circuit 104.

The image data output from the line delay adjustment circuit 102 are input into an adder 111. For each pixel, the adder 111 adds the image data to a value to be output to a D flip flop 112 in line with the timing of the pixel clock. The after-added value is input into the D terminal of the D flip flop 112, and the value is held in the D flip flop 112 at the timing of rise of the pixel clock input into an E terminal of the D flip flop 112. The value of the D flip flop 112 is cleared whenever the line synchronization signal input into a CLR terminal rises. In an AND circuit 113, one input thereof is 1 at all times, and the other input thereof is an output value of the D flip flop 112. Since the AND circuit 113 takes a logic sum thereof, the AND circuit 113 outputs a value of 1 when the output value of the D flip flop 112 is 0, and outputs a value of 0 when the output value of the D flip flop 112 is a value other than 0. Therefore, if the value of the respective pixel data for one line, which are input from the line delay adjustment circuit 102 into the determination circuit 104, are all 0s (to form a white image without causing the LEDs to emit light), the value of 1 is output; and if there is at least one piece of pixel data in which its value is 1 (to form a black image by causing the LEDs to emit light), the value of 0 is output. The output value is held in a D flip flop 114, and is output to the respective transfer prohibition circuit 106 as the transfer OFF signal. The D flip flop 114 holds the output value of the AND circuit 113 at a timing when the line synchronization signal input into an E terminal of the D flip flop 114 rises.

FIG. 16 is a circuit diagram showing a circuit configuration of the transfer prohibition circuit 106.

Each of the transfer prohibition circuit 106 is composed of an OR circuit. That is, the transfer prohibition circuits 106 composed of the OR circuits use the transfer signals CK1R, CK1C, CK2R and CK2C as an input signal, respectively. Also, all the transfer prohibition circuits 106 use a transfer OFF signal as an input signal. The respective transfer prohibition circuits 106 take a logic sum of these transfer signals and transfer OFF signals. As described above, since the transfer OFF signal outputs a value of 0 if there is at least one of the respective pixel data for one line. In this case, the transfer prohibition circuit 106 outputs 1 if the input transfer signal CK1R, CK1C, CK2R or CK2C is 1; and outputs 0 if the input transfer signal CK1R, CK1C, CK2R or CK2C is 0. Therefore, the transfer prohibition circuit 106 outputs the transfer signals CK1R, CK1C, CK2R and CK2C as they are. On the other hand, since the transfer OFF signal outputs a value of 1 if the respective image data for one line are all 0s. In this case, the value of 1 is continuously output at all times regardless of fluctuation of the values of the transfer signals CK1R, CK1C, CK2R and CK2C. Accordingly, in this case, the transfer prohibition circuit 106 fixes the transfer signals CK1R, CK1C, CK2R and CK2C at a H level, and prohibits the output thereof. Therefore, outputs of the transfer signals CK1 and CK2 will also be prohibited. If the thyristors corresponding to the LEDs L1, L2, L3 and L4, respectively, are the above-described thyristors S1, S2, S3 and S4, all the thyristors S1, S2, S3 and S4 are all turned off by the output prohibition of the transfer signals CK1 and CK2. In this case, each of the transfer signals CK1 and CK2 drives nine to ten LED chips 40, and six sets of the transfer signals CK1 and six sets of the transfer signals CK2 are provided (see FIG. 5). Therefore, the output prohibition of the transfer signals CK1 and CK2 is carried out for each group of nine to ten LED chips 40.

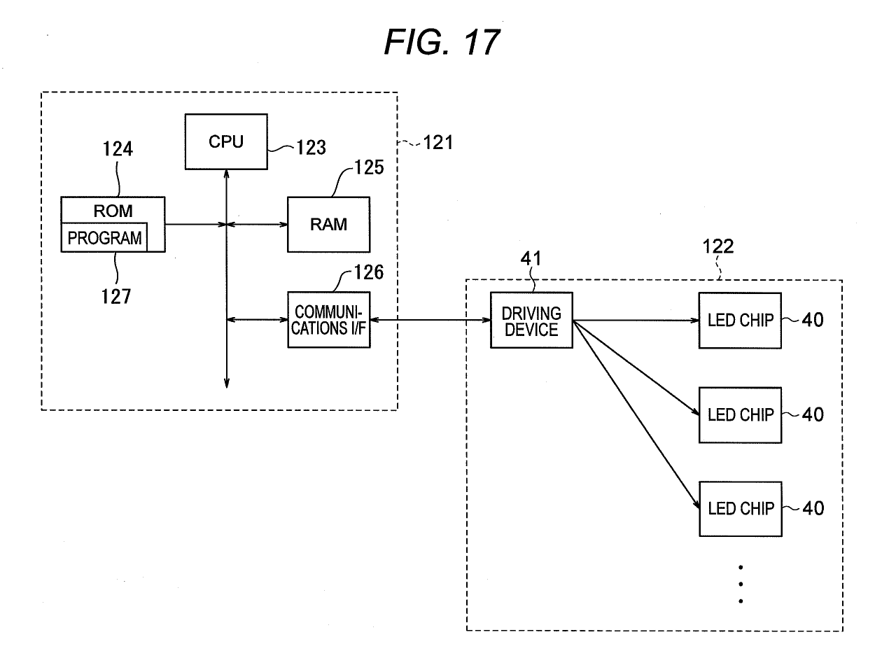

FIG. 17 is a block diagram for explaining the entire configuration of the control system of the exposure device described above.

A control device 121 is a microcomputer for controlling the entirety of an exposure device. The control device 121 is provided with a CPU 123 for intensively controlling respective portions of the exposure device. A ROM 124 storing a control program 127 executed by the CPU 123 and fixed data, a RAM 125 serving as a working area of the CPU 123, and a communications interface (I/F) 126 for communicates with the driving device 41 are connected to the CPU 123. The exposure device 121 operates based on control under the control device 121.

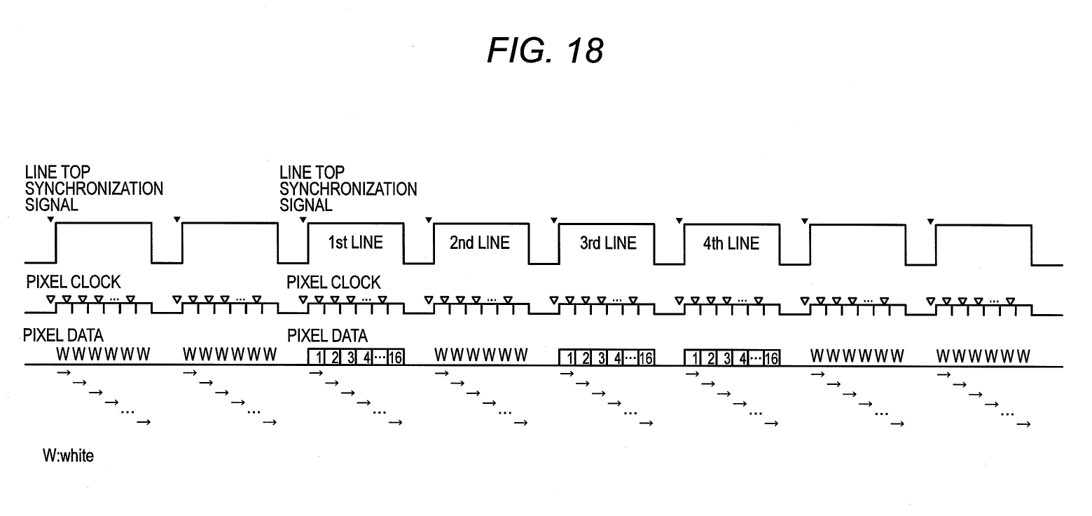

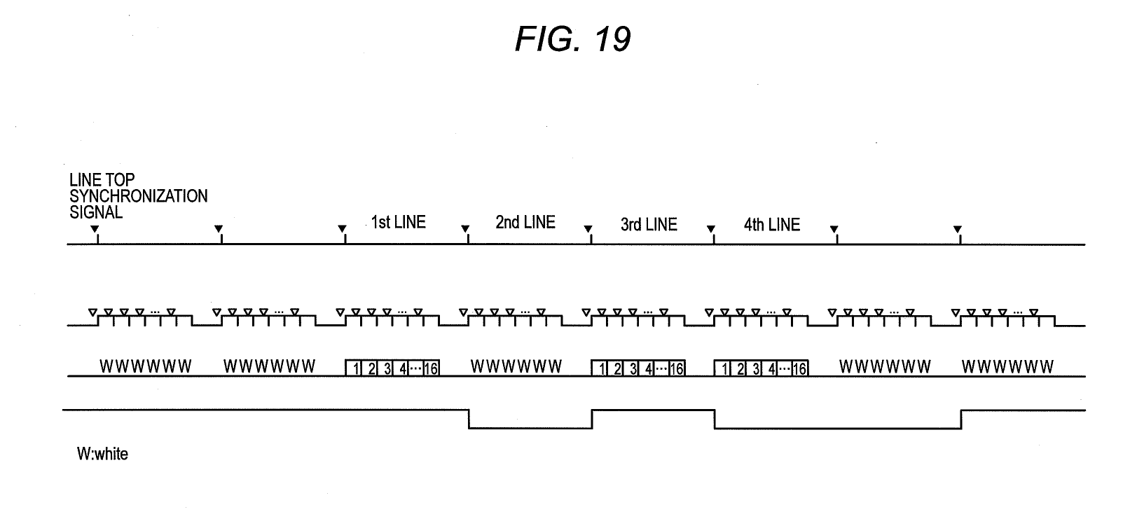

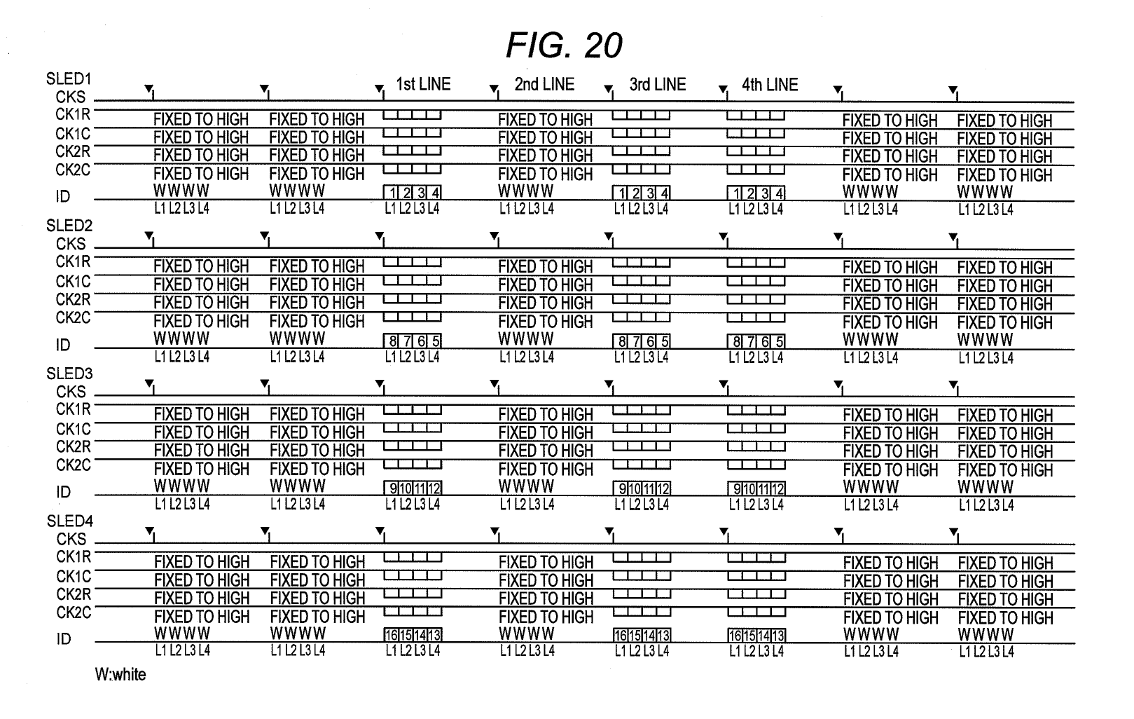

FIG. 18 through FIG. 20 are timing charts of the above-described circuits. FIG. 18 shows writing of image data from the control side to the FIFO memory 101. FIG. 19 shows writing of image data into the holding memory 103 for one line from reading of the image data from the FIFO memory 101. FIG. 20 shows output of image data to four LED chips 40 SLED1, SLED2, SLED3 and SLED4 from reading of the image data from the holding memory 103 for one line.

Here, the number of lines of the FIFO memory 101 is two lines. Delay in the FIFO memory 101 is two lines plus 1 pixel. Delay in the holding memory 103 for one line is 1 line plus 1 pixel. Also, here, with respect to the second line of the main scanning line, all the pixels are 0 (that is, to cause the LEDs not to emit light). Further, the reason why “Fixed to High” is expressed in the transfer signals CK1R, CK1C, CK2R and CK2C is that these transfer signals are fixed at H level by the transfer prohibition circuit 106 as described above. Also, “white” in the ID signal means that a pixel is a white pixel (that is, to cause the LED not to emit light).

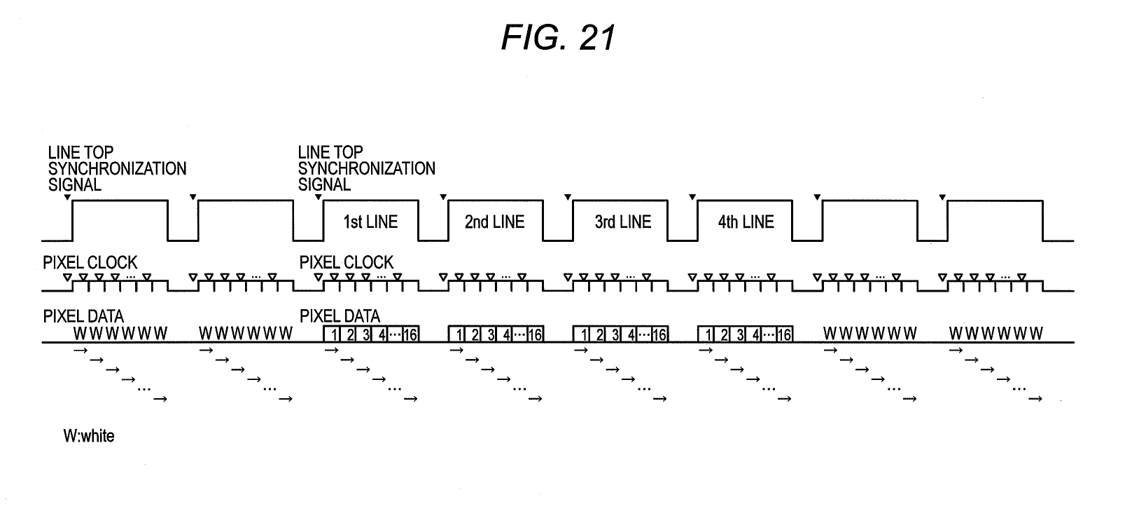

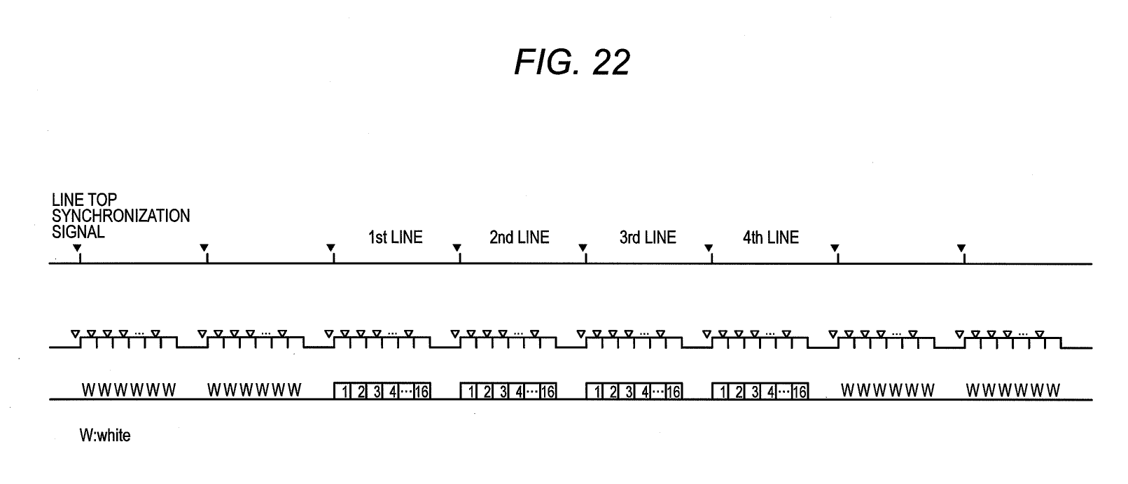

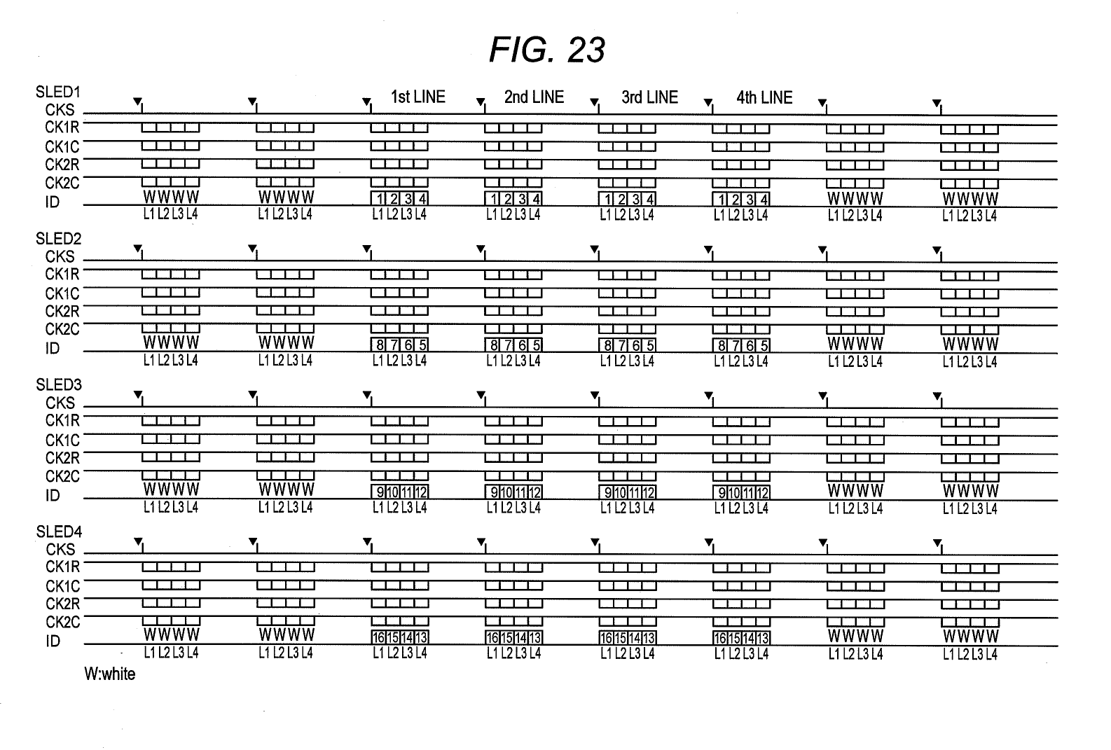

FIG. 21 through FIG. 23 are timing charts where any circuit coming after FIG. 12 is not provided in the above-described cases as a comparative example. FIG. 21 shows writing of image data from the control side into the FIFO memory 101. FIG. 22 shows writing of image data into the holding memory 103 for one line from reading of image data from the FIFO memory 101. FIG. 23 shows output of image data to the four LED chips 40 SLED1, SLED2, SLED3 and SLED4 from reading of the image data from the holding memory 103 for one line.

What is claimed is:

1. An exposure device comprising:
an exposure section having a plurality of light emitting elements;
a first signal output unit that outputs to the exposure section a first signal for determining a timing for starting light emission of the respective light emitting elements and a timing for ending the light emission of the respective light emitting elements; and
a second signal output unit that outputs to the exposure section a second signal for determining as to whether or not the respective light emitting elements are caused to emit light for respective pixels, wherein
if light mission of the respective light emitting elements is stopped with respect to all pixels of one line in a main scanning direction, the first signal output unit does not output the first signal to the exposure section for each group of one or plural light emitting elements that operate based on the common first signal.

2. The exposure device according to claim 1, wherein if light mission of the respective light emitting elements is not stopped with respect to all pixels of one line in a main scanning direction, the first signal output unit outputs the first signal to the exposure section.

3. An image forming apparatus comprising:
a photosensitive body;
an exposure section having a plurality of light emitting elements that form an electrostatic latent image by exposing the photosensitive body;
a developing unit that develops the electrostatic latent image with a toner;
a first signal output unit that outputs to the exposure section a first signal for determining a timing for starting light emission of the respective light emitting elements and a timing for ending the light emission of the respective light emitting elements; and
a second signal output unit that outputs to the exposure section a second signal for determining as to whether or not the respective light emitting elements are caused to emit light for respective pixels, wherein
if light mission of the respective light emitting elements is stopped with respect to all pixels of one line in a main scanning direction, the first signal output unit does not output the first signal to the exposure section for each group of one or plural light emitting elements that operate based on the common first signal.

4. The image forming apparatus according to claim 3, wherein if light mission of the respective light emitting elements is not stopped with respect to all pixels of one line in a main scanning direction, the first signal output unit outputs the first signal to the exposure section.

5. A computer-readable medium storing a program that causes a computer to execute an exposure control process, the exposure control process comprising:
controlling
an exposure section having a plurality of light emitting elements,
a first signal output unit that outputs to the exposure section a first signal for determining a timing for starting light emission of the respective light emitting elements and a timing for ending the light emission of the respective light emitting elements, and
a second signal output unit that outputs to the exposure section a second signal for determining as to whether or not the respective light emitting elements are caused to emit light for respective pixels,
so that if light mission of the respective light emitting elements is stopped with respect to all pixels of one line in a main scanning direction, the first signal is not output to the exposure section for each group of one or plural light emitting elements that operate based on the common first signal.

6. The computer-readable medium according to claim 5, wherein if light mission of the respective light emitting elements is not stopped with respect to all pixels of one line in a main scanning direction, the first signal is output to the exposure section.
